(19) United States
(12) Patent Application Publication
(10) Pub. No.: US 2026/0249370 A1
(43) Pub. Date: Aug. 27, 2026

(54) Dust and/or Chip Diversion Device and Handheld Power Tool

(71) Applicant: Robert Bosch GmbH, Stuttgart (DE)

(72) Inventors: Florian Esenwein, Leinfelden-Echterdingen (DE); Ashok Sivasankaran Nair, Bengaluru (IN); Chiranjeevi Reddy Doddi, Andhra Pradesh (IN); Gopinath Alagesan, Coimbatore (IN); Jaganathan Balasubramainam, Tirupur (IN); Manoj A, Srinagar (IN); Mohana Krishna Markonda, Bengaluru (IN); Rahul Ramesh Salian, Kamataka (IN); Tamilarasan Sundaramoorthy, Bangalore (IN)

(21) Appl. No.: 19/543,399

(22) Filed: Feb. 18, 2026

(30) Foreign Application Priority Data
Feb. 25, 2025 (DE) 10 2025 107 019.9

(51) Int. Cl. B23D 59/00; B27G 19/02; B27G 19/04

(52) U.S. Cl. CPC B23D 59/006; B27G 19/025; B27G 19/04

(57) ABSTRACT

A dust and/or chip diversion device for a handheld power tool includes a saw blade rotatable about a saw blade axis, with an upper saw blade guard, which is configured to permanently cover, at least to a large extent, a part of a saw blade area receiving the saw blade, which saw blade area faces away from a workpiece machining area, and with a lower saw blade guard movably mounted relative to the upper saw blade guard, which lower saw blade guard is configured to cover a part of the saw blade area facing toward the workpiece machining area in an idle state, and at least in a sawing operation, in which the saw blade is immersed in a workpiece, to release the part of the saw blade area facing toward the workpiece machining area by at least partially retracting into the upper saw blade guard, wherein the lower saw blade guard includes a dust and/or chip diversion aperture, via which dust generated by the rotating saw blade and/or chips generated by the rotating saw blade may be diverted from the saw blade area. The dust and/or chip diversion device includes a flow orientation unit configured to selectively divert dust and/or chip particles passing through the dust and/or chip diversion aperture from a radial direction perpendicular to the saw blade axis.

This application claims priority under 35 U.S.C. § 119 to patent application no. DE 10 2025 107 019.9, filed on Feb. 25, 2025 in Germany, the disclosure of which is incorporated herein by reference in its entirety.

### BACKGROUND

A dust and/or chip diversion device for a handheld power tool, which comprises a saw blade that generates dust and/or chips and is rotatable about a saw blade axis, with an upper saw blade guard, which is configured to permanently cover, at least to a large extent, a part of a saw blade area receiving the saw blade, which saw blade area of the handheld power tool faces away from a workpiece machining area, and with a lower saw blade guard movably mounted relative to the upper saw blade guard, which lower saw blade guard is configured to cover, at least to a large extent, a part of the saw blade area facing toward the workpiece machining area in an idle state, and at least in a sawing operation, in which the saw blade is immersed in a workpiece, to at least partially release the part of the saw blade area facing toward the workpiece machining area at least by at least partially retracting into the upper saw blade guard, wherein the lower saw blade guard comprises a dust and/or chip diversion aperture, via which dust generated by the rotating saw blade and/or chips generated by the rotating saw blade may be diverted from the saw blade area, has already been proposed. The known dust and/or chip diversion apertures run along the circumferential direction of the lower saw blade guard or are transverse elongated holes that only permit the dust or chip particles to pass through the lower saw blade guard but do not perform targeted flow guidance or flow shaping. Particles can escape from the saw blade area perpendicular to the circumferential direction, among other things, so that undesirable vortices can occur in the intermediate space between the lower saw blade guard and the upper saw blade guard. As a result, too many particles do not go to a suction nozzle or a collection container of the upper saw blade guard, but instead escape from it at another location into the surrounding environment.

### SUMMARY

The disclosure relates to a dust and/or chip diversion device for a handheld power tool, which comprises a saw blade that generates dust and/or chips and is rotatable about a saw blade axis, with an upper saw blade guard, preferably arranged in a stationary manner, which is configured to permanently cover, at least to a large extent, a part of a saw blade area receiving the saw blade, which saw blade area of the handheld power tool faces away from a workpiece machining area, and with a lower saw blade guard movably mounted, particularly movably mounted rotationally about the saw blade axis, relative to the upper saw blade guard, which lower saw blade guard is configured to cover, at least to a large extent, a part of the saw blade area facing toward the workpiece machining area in an idle state, and at least in a sawing operation, in which the saw blade is immersed in a workpiece, to at least partially release the part of the saw blade area facing toward the workpiece machining area at least by at least partially retracting into the upper saw blade guard, wherein the lower saw blade guard comprises a dust and/or chip diversion aperture, via which dust generated by the rotating saw blade and/or chips generated by the rotating saw blade may be diverted from the saw blade area, in particular into a hollow space of the upper tool guard, into which the lower saw blade guard has been at least partially retracted in a state of the handheld power tool generated dust and/or chips. Advantageously, vortices in an airflow comprising the dust or chip particles inside the handheld power tool may be prevented or at least reduced compared to the prior art. As a result, in particular, a dust or chip particle-containing airflow, which exits in the direction of the saw blade axis between lateral walls of the upper saw blade guard and the lower saw blade guard, can be reduced.

It is proposed that the dust and/or chip diversion device, in particular the dust and/or chip diversion aperture, comprises a flow orientation unit, which is at least configured to selectively divert at least dust and/or chip particles passing through the dust and/or chip diversion aperture from a radial direction perpendicular to the saw blade axis. Advantageously, flow shaping can be achieved, which in particular directs a greater proportion of dust or chip particles to a connection interface for a dust and/or chip container and/or a vacuum cleaner hose of the upper saw blade guard. Advantageously, a portion and a number of dust or chip particles exiting the handheld power tool may be reduced and/or kept low so that a health burden for a user of the handheld power tool may be minimized. Advantageously, a “dust capture rate” can be increased compared to the prior art.

The dust and/or chip diversion device is in particular a part/component of a handheld power tool. Preferably, the dust and/or chip diversion device is configured to selectively conduct and/or guide dust or chip particles generated during machining of a part by the handheld power tool. Preferably, the handheld power tool is a handheld circular saw. In particular, the handheld power tool is a wireless, preferably battery-powered, handheld circular saw. Wireless handheld circular saws collect the dust and the chips, preferably in dust bags or dust boxes, rather than being connected to an external suction device, as this would negate the mobility gained by the wireless system. Therefore, in the case of wireless handheld circular saws, the flow direction of the exhaust air comprising the dust or chip particles is even more important, since there is then no support or external flow guidance through an intake of the external suction device. The saw blade of the handheld power tool is rotatable about a fixed saw blade axis. The handheld power tool comprises a saw blade area configured to interchangeably receive the saw blade. The saw blade is preferably a circular saw blade with saw teeth on its outer circumference. For example, the saw blade may be configured for machining pieces of woodwork. However, other types of materials may also be sawn. According to the sawn parts, the dust or chip particles are also configured differently. “Configured” should be understood to mean specifically programmed, designed, and/or equipped. In particular, the fact that an object is configured for a specific function should be understood to mean that the object fulfills and/or executes this specific function in at least one application state and/or operating state.

The upper saw blade guard is in particular configured as an upper saw blade hood. The upper saw blade guard preferably comprises an approximately semi-circular interior space (hereinafter also called a hollow space of the upper saw blade guard), which is configured to completely enclose a part of the saw blade. The upper saw blade guard preferably prevents contact with the saw blade from above. The upper saw blade guard is preferably arranged in a stationary manner relative to a drive unit of the handheld power tool, a battery of the handheld power tool, and/or a main handle of the handheld power tool. In this context, “a large extent” should be understood to mean particularly 51%, preferably 60%, and ideally, 70%. The workpiece machining area of the handheld power tool is in particular the area of the handheld power tool, in which the workpiece may be positioned during the intended machining by the saw blade. In particular, the upper saw blade guard is configured to permanently cover, at least to a large extent, an upper part of the saw blade area of the handheld power tool and the saw blade mounted therein. The upper saw blade guard is permanently arranged on the same, in particular above the upper side of a saw table of the handheld circular saw.

The lower saw blade guard is in particular configured as a lower saw blade hood. The lower saw blade guard preferably comprises a semi-circular, in particular somewhat smaller than semi-circular, internal space, which is arranged to completely enclose a part of the saw blade. The lower saw blade guard preferably prevents contact with the saw blade from below in the idle state of the handheld circular saw. The lower saw blade guard is arranged on an opposite side of the saw table of the handheld circular saw than the upper saw blade guard in the idle state of the handheld circular saw. The lower saw blade guard is arranged on the same side of the saw table of the handheld circular saw as the upper saw blade guard during the sawing operation of the handheld circular saw. The lower saw blade guard may comprise a handle that allows the lower saw blade guard to be moved/rotated relative to the upper saw blade guard prior to placing a workpiece. Alternatively, it is also conceivable that the lower saw blade guard automatically moves/is displaced when machining of a workpiece is performed. In particular, at least one outer circumference of the lower saw blade guard moves during the displacement of the lower saw blade guard on a circular track centered about the saw blade axis of the handheld power tool/the saw blade. Preferably, all points on the lower saw blade guard move in circular tracks about the saw blade axis upon displacement. In particular, during the sawing operation, the lower saw blade guard releases all of the area of the saw blade that protrudes below the saw table.

Preferably, the lower saw blade guard fits within the interior space of the upper saw blade guard (between the saw blade area and the outer wall of the upper saw blade guard). Preferably, the upper saw blade guard overlaps the lower saw blade guard to a large extent during the sawing operation. In particular, when the lower saw blade guard is retracted into the upper saw blade guard, the lower saw blade guard is rotated into the stationary upper saw blade guard. In particular, the lower saw blade guard slides into the upper saw blade guard between the saw blade and the outer wall of the upper saw blade guard upon retraction. In particular, the lower saw blade guard retracted into the upper saw blade guard divides a space between the saw blade and the outer wall of the upper saw blade guard into two parts, in particular a radial part facing toward the saw blade and a radial part facing away from the saw blade. These two parts are preferably connected to each other via the dust and/or chip diversion aperture(s). The dust and/or chip diversion aperture allows for exchange of air and dust or chips between these two parts. In particular, the dust or chip particles generated by the rotating saw blade can be transferred/transported/diverted, via the dust and/or chip diversion aperture, from the saw blade area into an intermediate space between the retracted lower saw blade guard and the upper saw blade guard, preferably between a radial external surface of the lower saw blade guard and a radial internal surface of the upper saw blade guard. In particular, the dust and/or chip diversion aperture is different from an elongated hole extending along the circumferential direction of a radial outer side of the lower saw blade guard. In particular, the dust and/or chip diversion aperture is different from a purely spoiler-free hole extending in the radial direction.

The flow orientation unit is preferably formed in one piece, in particular monolithically, with the lower saw blade guard. The flow orientation unit is preferably formed by the lower saw blade guard/by parts of the lower saw blade guard.

Furthermore, it is proposed that the flow orientation unit is configured to divert the dust and/or chip particles passing through the dust and/or chip diversion aperture at least in a lateral direction that is angled with respect to a saw blade surface of the saw blade area. Advantageous flow paths can thereby be achieved. Advantageously, vortices within the intermediate space between the lower saw blade guard and the upper saw blade guard may be directed inwardly (as opposed to one direction outwardly when the airflow could simply leave the dust and/or chip diversion aperture in the radial direction). In particular, the airflow exiting through the dust and/or chip diversion aperture formed in this way will encounter the particles obliquely on an inner side wall of the upper saw blade guard, and will then be reflected from the wall upwardly obliquely so that the reflected airflow is then diverted from a radial inner wall in the direction of a center of the lower saw blade guard. In particular, the airflow is generated by the rotating saw blade and pushed radially outward, i.e., onto an inner side of the retracted lower saw blade guard and/or through dust and/or chip diversion apertures of the lower saw blade guard due to centrifugal forces. For example, the lateral direction is angled relative to the radial direction/the saw blade surface at an angle in the range of 20° to 70°, preferably from 30° to 60°, preferably from 40° to 50°, and more preferably about 45°.

If the lower saw blade guard comprises at least one further dust and/or chip diversion aperture, which is arranged adjacent the dust and/or chip diversion aperture in a direction parallel to the saw blade axis, removal of the dust or chip particles may advantageously be improved. Advantageously, in particular many/preferably almost all dust or chip particles can be removed from the saw blade area.

If the flow orientation unit is also configured to divert the dust and/or chip particles passing through the further dust and/or chip diversion aperture at least in a further lateral direction that is oppositely angled with respect to the saw blade surface of the saw blade area in comparison to the lateral direction, a particularly advantageous flow path can be achieved. Advantageously, a swirling of the airflows comprising dust or chip particles exiting from the dust and/or chip diversion aperture and the further dust and/or chip diversion aperture may be achieved. Advantageously, in particular, a dust or chip particle-containing airflow, which exits in the direction of the saw blade axis between lateral walls of the upper saw blade guard and the lower saw blade guard, can be reduced. Preferably, the diversion directions of the airflows exiting the dust and/or the chip diversion aperture and the further dust and/or the chip diversion aperture are symmetrical mirror images relative to the saw blade surface. Preferably, flow orientation elements of the flow orientation unit associated with the two dust and/or chip diversion apertures are symmetrical mirror images with respect to the saw blade surface.

Furthermore, it is proposed that a recess, in particular a vortical chamber, is arranged on a radial outer side of the lower saw blade guard between the dust and/or the chip diversion aperture and the further dust and/or the chip diversion aperture. As a result, a particularly advantageous flow path can be achieved. Advantageously, the swirling of the airflows comprising dust or chip particles exiting from the dust and/or chip diversion aperture and the further dust and/or chip diversion aperture may be optimized. The recess preferably has a symmetrical shell shape in a cross-sectional view. The recess extends in the circumferential direction in particular at least as far as the dust and/or chip diversion aperture, preferably at least as far as all dust and/or chip diversion apertures, of the lower saw blade guard together.

In addition, it is proposed that the flow orientation unit is configured to divert the dust and/or chip particles passing through the dust and/or chip diversion aperture, in particular in addition to or alternatively to the lateral diversion, at least in a, particularly outwardly oriented, direction which is parallel to a saw blade surface of the saw blade area and angled with respect to the radial direction. As a result, advantageous flow guidance can in particular be achieved, which is in particular directed toward the connection interface for the dust and/or the chip container and/or for the vacuum cleaner hose. In particular, the diversion direction parallel to a saw blade surface of the saw blade area and angled with respect to the radial direction is at least partially oriented toward/at the connection interface for the dust and/or chip container and/or for the vacuum cleaner hose formed by the upper saw blade guard. Advantageously, in the case of a flow exclusively aligned as described above, as much laminar inflow as possible can be achieved with respect to the airflow with the dust or chip particles into the intermediate space between the two saw blade guards. Advantageously, turbulences can be avoided.

If the, particularly outwardly oriented, direction into which the dust and/or chip particles passing through the dust and/or chip diversion aperture are diverted from the flow orientation unit is different from a tangential direction of the saw blade/saw blade area, at least undesirable types of vortices may advantageously be avoided or reduced. Advantageously, a high laminarity of the airflow can be achieved. Advantageously, an optimum orientation of the airflow, in particular to the connection interface, can be achieved.

In addition, if an angle between the tangential direction of the saw blade/saw blade area and the, particularly outwardly oriented, direction into which the flow orientation unit diverts the dust and/or chip particles passing through the dust and/or chip diversion aperture is less than 60°, preferably less than 45°, the aforementioned advantages of diversion from the tangential direction can be further optimized.

In addition, it is proposed that the lower saw blade guard comprises at least one additional dust and/or chip diversion aperture arranged in an external circumferential direction around the saw blade area in front of or behind the dust and/or chip diversion aperture. As a result, the removal of the dust or chip particles is advantageously improved. Advantageously, in particular many/preferably almost all dust or chip particles can be removed from the saw blade area. Advantageously, flow rates through the dust and/or chip diversion apertures may be lowered, thereby particularly improving the laminarity of the airflow. Preferably, the dust and/or chip diversion device comprises a plurality of additional dust and/or chip diversion apertures, for example, two additional dust and/or chip diversion apertures, three additional dust and/or chip diversion apertures, four additional dust and/or chip diversion apertures, or more than four additional dust and/or chip diversion apertures. For larger saw blade areas and larger saw blades, higher numbers of additional dust and/or chip diversion apertures may be more useful than for smaller saw blade areas and smaller saw blades. The additional dust and/or chip diversion aperture may be arranged directly behind the dust and/or chip diversion aperture or may be laterally offset from the dust and/or chip diversion aperture. The additional dust and/or chip diversion aperture is preferably identical to the dust and/or chip diversion aperture. However, alternatively, different aperture shapes and/or sizes could also be conceivable.

In addition, it is proposed that in a state of the lower saw blade guard being maximally retracted into the upper saw blade guard, the dust and/or chip diversion aperture and the additional dust and/or chip diversion aperture are each differently spaced apart from the interior walls of the upper saw blade guard. A stable flow/a stable flow structure can thus be advantageously achieved. Advantageously, it can be avoided that the flowing air with the particles is unnecessarily accelerated or pushed down laterally between the two saw blade guards. The different spacings of the successive dust and/or chip diversion apertures from the respective opposite interior walls of the upper saw blade guard can be achieved by a corresponding design of the outermost wall of the upper saw blade guard or by an intermediate wall inserted in an interior of the upper saw blade guard. In particular, a spacing of an interior wall of the upper saw blade guard opposite to a dust and/or chip diversion aperture arranged closer to the connection interface is greater than a spacing of an interior wall of the upper saw blade guard opposite to a dust and/or chip diversion aperture arranged further away from the connection interface. As a result, the air exiting the closer dust and/or chip diversion aperture may be added to the air already flowing to the connection interface without significantly increasing flow rates.

Furthermore, it is proposed that the dust and/or chip diversion aperture may be partially or entirely arranged on an axial lateral surface of the lower saw blade guard. As a result, flow rates in the intermediate space between the saw blade guards may be advantageously kept low, which in particular supports/promotes the laminarity of the flow. In addition, or alternatively, the dust and/or chip diversion aperture may be arranged at least partially or entirely on a radial outer side of the lower saw blade guard. In particular, the dust and/or chip diversion aperture may extend from a lateral surface of the lower saw blade guard above a radial outer side of the lower saw blade guard and above the lateral surface of the lower saw blade guard opposite such lateral surface. However, it is also conceivable that the dust and/or chip diversion aperture is only arranged on the radial outer side of the lower saw blade guard or only on one of the two lateral surfaces of the lower saw blade guard.

If the flow orientation unit is formed at least partially by a channel running obliquely through a wall, in particular a lateral wall or a radial outer wall, of the lower saw blade guard, a simple and/or reliable flow direction can advantageously be achieved. Advantageously, a compact design of the flow orientation unit can be achieved. The channel running obliquely through the wall preferably does not run parallel to the radial direction. The channel running obliquely through the wall may run at an angle that differs from the radial direction with respect to the saw blade surface, in particular that differs by 0° and 90°, and may particularly run at the aforementioned angle between the tangential direction of the saw blade/the saw blade area and the direction, into which the flow orientation unit diverts the dust and/or chip diversion particles passing through the dust and/or chip apertures. Alternatively or additionally, the channel running obliquely through the wall may run at an angle that differs from the plane of the saw blade surface, in particular that differs by 0° and 90°. In particular, the channel forms a flow orientation element of the flow orientation unit.

Alternatively or in addition to the channel running obliquely through the wall, it is suggested that the flow orientation unit is formed at least partially by a tab/spoiler that protrudes externally at least partially over the dust and/or chip diversion aperture. As a result, a simple design of the flow orientation unit can advantageously be achieved. Advantageously, a particularly simple setting of the diversion angle can be enabled. The tab may be opened or closed laterally. In particular, the tab forms a flow orientation element of the flow orientation unit. Multiple consecutive dust and/or chip diversion apertures equipped with tabs particularly result in a flow orientation unit structure reminiscent of gills.

In addition, it is proposed that the upper saw blade guard comprises the connection interface for a dust and/or a chip container and/or for a vacuum cleaner hose. This may advantageously enable collection or removal of the dust or chip particles. Advantageously, health protection may be improved for the user of the handheld power tool equipped with the dust and/or chip diversion device.

Furthermore, the handheld power tool, in particular, a handheld circular saw, with a saw blade area, into which a saw blade can be mounted, such that a workpiece arranged in a workpiece machining area of the handheld power tool can be machined by way of the saw blade, and with a drive unit to generate a rotation of the saw blade arranged in the saw blade area about a saw blade axis of the drive unit, and with the previously described dust and/or chip diversion device, is proposed. Advantageously, a portion and a number of dust or chip particles exiting the handheld power tool may be reduced and/or kept low so that a health burden for a user of the handheld power tool may be minimized. Advantageously, the dust capture rate of the handheld power tool can be optimized.

The dust and/or chip diversion device according to the disclosure and/or the handheld power tool according to the disclosure should not thereby be limited to the application and embodiment described above. In particular, the dust and/or chip diversion device according to the disclosure and/or the handheld power tool device according to the disclosure can have a number of individual elements, components and units that differs from a number specified herein in order to fulfill a mode of operation described herein. Moreover, for the value ranges specified in this disclosure, values lying within the mentioned limits are also provided to be regarded as disclosed and as arbitrarily usable.

### BRIEF DESCRIPTION OF THE DRAWINGS

Further advantages follow from the description of the drawings below. Four exemplary embodiments of the disclosure are shown in the drawing. The drawings, the description, and the claims contain numerous features in combination. A person skilled in the art will also appropriately consider the features individually and combine them into further meaningful combinations.

It shows:

FIG. 1 a schematic side view of a handheld power tool with a dust and/or chip diversion device in an idle state,

FIG. 2 a schematic cross-sectional view of the handheld power tool with the dust and/or chip diversion device in a sawing operation,

FIG. 3 a schematic cross-sectional view through a part of a lower saw blade guard of the dust and/or chip diversion device,

FIG. 4 a schematic perspective view of a lower saw blade guard of an alternative dust and/or chip diversion device,

FIG. 5 a schematic cross-sectional view through a part of a second alternative dust and/or chip diversion device; and

FIG. 6 a schematic cross-sectional view through a part of a third alternative dust and/or chip diversion device.

### DETAILED DESCRIPTION

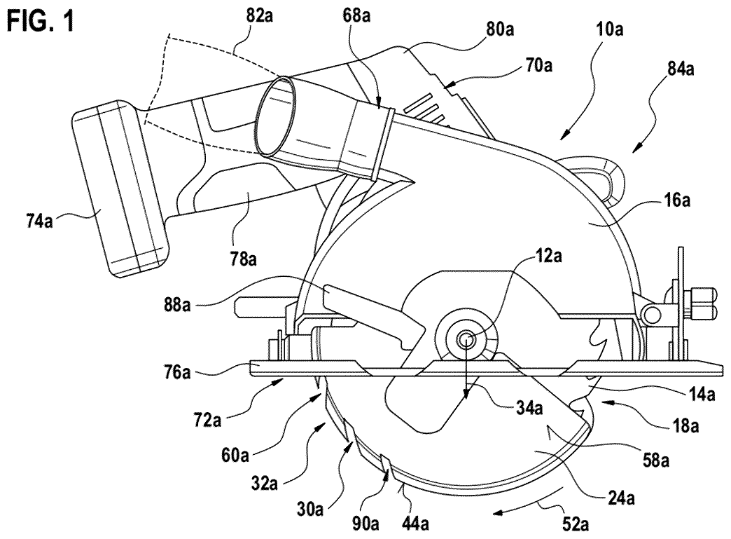

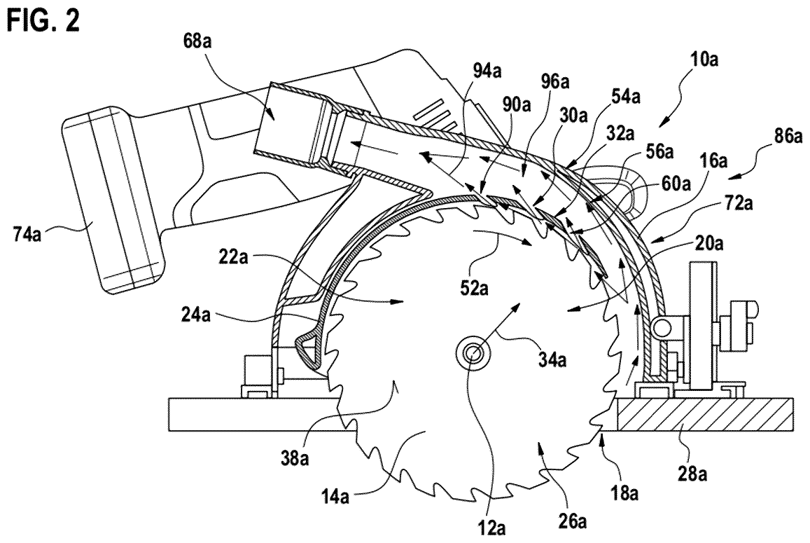

FIG. 1 shows a schematic side view of a handheld power tool 10a. The handheld power tool 10a is configured as a handheld circular saw. The handheld power tool 10a is wireless. The handheld power tool 10a comprises a battery 74a. The battery 74a is configured to provide electric drive power to the handheld power tool 10a. The handheld power tool 10a comprises a main handle 78a. The handheld power tool 10a comprises a housing 80a. The housing 80a integrally forms the main handle 78a. The handheld power tool 10a comprises a drive unit 70a. The drive unit 70a includes an electric motor (not shown) powered by the battery 74a and enclosed by the housing 80a. The drive unit 70a includes a saw blade axis 12a. The drive unit 70a is configured to rotate the saw blade axis 12a. The handheld power tool 10a comprises a saw blade area 22a. A saw blade 14a can be mounted in the saw blade area 22a. In the exemplary embodiment shown in FIG. 1, a saw blade 14a is mounted in the saw blade area 22a. The saw blade 14a is mounted in the saw blade area 22a such that a workpiece 28a (see FIG. 2) can be machined by way of the saw blade 14a driven by the drive unit 70a via the saw blade axis 12a in a workpiece machining area 18a of the handheld power tool 10a. The saw blade 14a is rotatably attached about the saw blade axis 12a in the handheld power tool 10a. The saw blade 14a generates dust and/or chips during a sawing operation 86a. The handheld power tool 10a comprises the workpiece machining area 18a. The handheld power tool 10a comprises a saw table 76a. The workpiece machining area 18a is arranged entirely on one side of the saw table 76a. The workpiece machining area 18a is arranged entirely on a side opposite to the drive unit 70a and/or the accumulator 74a. The workpiece machining area 18a is arranged entirely below the saw table 76a. A dust and/or chip container 82a is mounted on the handheld power tool 10a. The dust and/or chip container 82a is configured to collect and receive dust or chip particles generated during machining of the workpiece 28a. The dust and/or chip container 82a is configured as a sack, by way of example. The dust and/or chip container 82a is interchangeable.

The handheld power tool 10a comprises a dust and/or chip diversion device 72a. The dust and/or chip diversion device 72a comprises an upper saw blade guard 16a. The upper saw blade guard 16a is fixedly arranged/attached in the handheld power tool 10a. The upper saw blade guard 16a is configured to permanently cover a part 20a of the saw blade area 22a receiving the saw blade 14a facing away from the workpiece machining area 18a, and thus also the same part of the mounted saw blade 14a. The upper saw blade guard 16a comprises a connection interface 68a for the dust and/or chip container 82a. Alternatively, or additionally, it is also conceivable that the connection interface 68a may allow connection of a vacuum cleaner hose. The saw table 76a is attached/mounted to the upper saw blade guard 16a.

The dust and/or chip diversion device 72a comprises a lower saw blade guard 24a. The lower saw blade guard 24a is movably mounted relative to the upper saw blade guard 16a. The lower saw blade guard 24a is rotationally movably mounted about the saw blade axis 12a. The lower saw blade guard 24a is configured to cover, at least to a large extent, a part 26a of the saw blade area 22a facing toward the workpiece machining area 18a, and thus the same part of the mounted saw blade 14a, at least in an idle state 84a of the handheld power tool 10a, which is shown in particular in FIG. 1. The lower saw blade guard 24a is configured to at least partially release the part 26a of the saw blade area 22a facing toward the workpiece machining area 18a by way of at least partial retraction into the upper saw blade guard 16a during a sawing operation 86a, in which the saw blade 14a is immersed in the workpiece 28a, which is particularly shown in FIG. 2. The lower saw blade guard 24a comprises a control lever 88a. The control lever 88a allows the user of handheld power tool 10a to manually retract lower saw blade guard 24a into the upper saw blade guard 16a. The control lever 88a allows the user of handheld power tool 10a to manually rotate the lower saw blade guard 24a. The lower saw blade guard 24a comprises a dust and/or chip diversion aperture 30a. The lower saw blade guard 24a comprises an additional dust and/or chip diversion aperture 60a. The additional dust and/or chip diversion aperture 60a is arranged in an external circumferential direction 52a around the saw blade area 22a in front of the dust and/or chip diversion aperture 30a. In the exemplary embodiment shown in FIGS. 1 and 2, a second additional dust and/or chip diversion aperture 90a is also configured. Alternatively, more or less than two additional dust and/or chip diversion apertures 60a, 90a could also be configured. The dust and/or chip diversion apertures 30a, 60a, 90a are partially arranged on one, in particular axial to the saw blade axis 12a, lateral surface 58a/lateral wall of the lower saw blade guard 24a. The dust and/or chip diversion apertures 30a, 60a, 90a are partially arranged on a radial outer side 44a of the lower saw blade guard 24a. Alternatively, the dust and/or chip diversion apertures 30a, 60a, 90a could also only be arranged on the radial outer side 44a of the lower saw blade guard 24a.

FIG. 2 shows a schematic cross-sectional view of handheld power tool 10a with the dust and/or chip diversion device 72a during the sawing operation 86a, in which saw blade 14a is submerged in the workpiece 28a. The lower saw blade guard 24a is retracted into the upper saw blade guard 16a. The lower saw blade guard 24a is arranged inside the upper saw blade guard 16a. The rotating saw blade 14a generates an airflow 94a. The airflow 94a includes dust or chip particles (not shown) of the workpiece 28a. The airflow 94a is to be directed to the connection interface 68a via the dust and/or chip diversion device 72a. The dust and/or chip diversion apertures 30a, 60a, 90a are configured to divert the dust generated by the rotating saw blade 14a and/or the chips generated by the rotating saw blade 14a from the saw blade area 22a. The dust and/or chip diversion apertures 30a, 60a, 90a are configured to divert the dust generated by the rotating saw blade 14a and/or the chips generated by the rotating saw blade 14a from the saw blade area 22a into in intermediate space 96a between an inner wall of the upper saw blade guard 16a and an external wall of the lower saw blade guard 24a. In the state of the lower saw blade guard 24a being maximally retracted into the upper saw blade guard 16a, shown in FIG. 2, the dust and/or chip diversion apertures 30a, 60a, 90a are each spaced differently apart from the radially directly opposite inner wall areas 54a, 56a of the upper saw blade guard 16a.

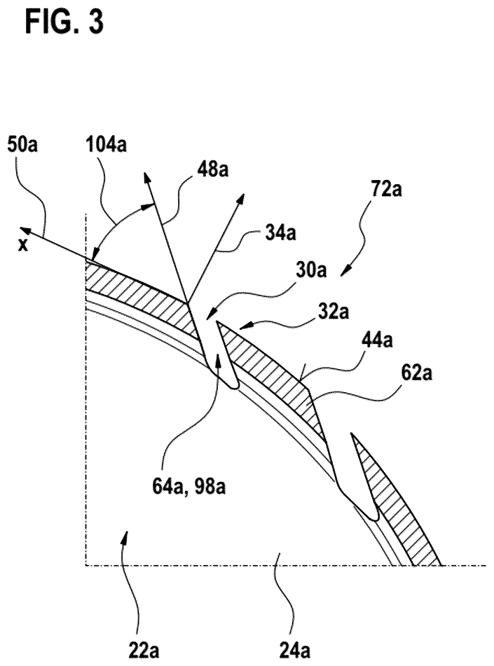

The dust and/or chip diversion device 72a comprises a flow orientation unit 32a. The flow orientation unit 32a is configured at least to selectively divert dust and/or chip particles passing through the dust and/or chip diversion apertures 30a, 60a, 90a from a radial direction 34a of the saw blade area 22a perpendicular to the saw blade axis 12a. FIG. 3 schematically shows a cross-section through part of the lower saw blade guard 24a. The flow orientation unit 32a comprises a flow orientation element 98a. The flow orientation element 98a is formed by a channel 64a running obliquely through a wall 62a of the lower saw blade guard 24a. The flow orientation unit 32a, in particular, the associated flow orientation element 98a, is configured to divert the dust and/or chip particles passing through the dust and/or chip diversion apertures 30a, 60a, 90a, or the airflow 94a with dust and/or chip particles passing through the dust and/or chip diversion apertures 30a, 60a, 90a in an outwardly oriented direction 48a, which is parallel to a saw blade surface 38a of the saw blade area 22a and angled with respect to the radial direction 34a. The outwardly oriented direction 48a, into which the dust and/or chip particles passing through the dust and/or chip diversion apertures 30a, 60a, 90a, or the airflow 94a with dust and/or chip particles passing through the dust and/or chip diversion apertures 30a, 60a, 90a is/are diverted from the flow orientation unit 32a, in particular, the associated flow orientation element 98a, is distinct from a tangential direction 50a of the saw blade 14a and/or the saw blade area 22a. An angle 104a between the tangential direction 50a of the saw blade 14a/of the saw blade area 22a and the outwardly oriented direction 48a, into which the flow orientation unit 32a, in particular the flow orientation element 98a of the flow orientation unit 32a, diverts the airflow 94a having the dust and/or chip particles and passing through the dust and/or chip diversion aperture 30a, is less than 60°. The channel 64a is angled/aligned in the same direction as the saw teeth of the saw blade 14a relative to the radial direction 34a. The channel 64a is aligned in the direction of rotation of the saw blade 14a relative to the radial direction 34a.

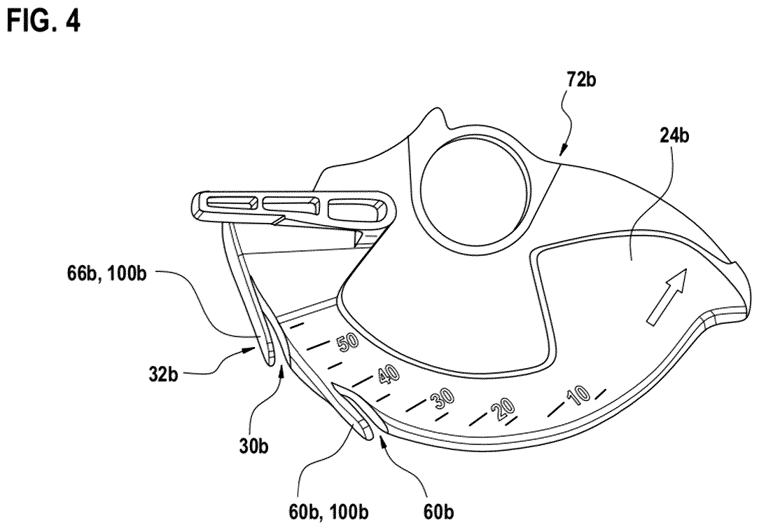

FIG. 4 to 6 show three further exemplary embodiments of the disclosure. The following descriptions and the drawings are substantially limited to the differences between the exemplary embodiments, wherein reference may also be made in principle to the drawings and/or the description of the other exemplary embodiments, in particular FIGS. 1 to 3, with regard to components with the same reference numerals, in particular with regard to components having the same reference signs. To differentiate between the exemplary embodiments, the letter a is placed after the reference numerals of the exemplary embodiment in FIGS. 1 to 3. In the exemplary embodiments of FIGS. 4 through 6, the letter a is replaced by letters b to d.

In FIG. 4, a lower saw blade guard 24b of an alternative dust and/or chip diversion device 72b is shown schematically and in a perspective view. The lower saw blade guard 24b comprises dust and/or chip diversion apertures 30b, 60b. The alternative dust and/or chip diversion device 72b comprises an alternative flow orientation unit 32b. The alternative flow orientation unit 32b includes an alternative flow orientation element 100b for each dust and/or chip diversion aperture 30b, 60b. The alternative flow orientation element 100b is formed as a tab 66b. The tab 66b extends outwardly above the associated dust and/or chip diversion aperture 30b.

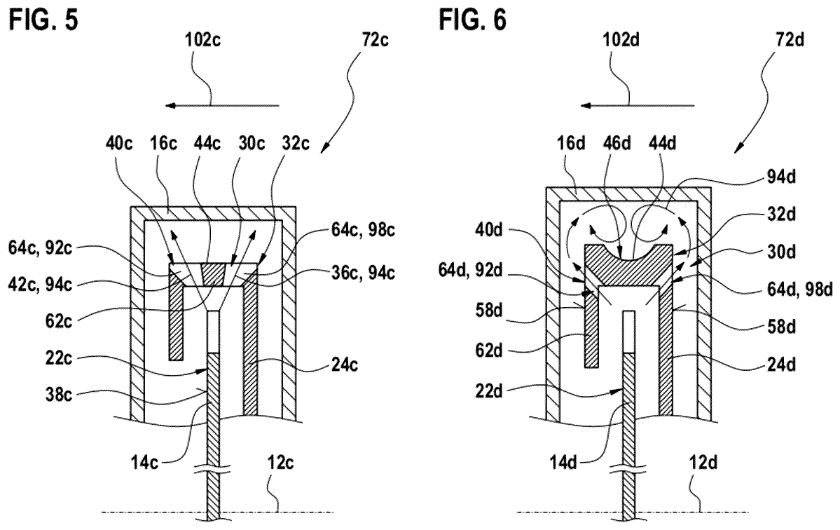

In FIG. 5, a schematic cross-sectional view is shown through a portion of a second alternative dust and/or chip diversion device 72c and through a portion of a saw blade 14c. The second alternative dust and/or chip diversion device 72c comprises an upper saw blade guard 16c and a lower saw blade guard 24c that can be retracted into the upper saw blade guard 16c. In the illustration of FIG. 5, the lower saw blade guard 24c is retracted straight into the upper saw blade guard 16c. The lower saw blade guard 24c comprises a dust and/or chip diversion aperture 30c. The lower saw blade guard 24c comprises a further dust and/or chip diversion aperture 40c. The further dust and/or chip diversion aperture 40c is arranged adjacent to the dust and/or chip diversion aperture 30c in a direction 102c extending parallel to a saw blade axis 12c and/or perpendicular to a circumferential direction of the saw blade 14c or a saw blade area 22c of the second alternative dust and/or chip diversion device 72c. The dust and/or chip diversion apertures 30c, 40c are arranged solely in a radial outer side 44c of the lower saw blade guard 24c. The second alternative dust and/or chip diversion device 72c comprises a flow orientation unit 32c. The flow orientation unit 32c includes a flow orientation element 98c associated with the dust and/or chip diversion aperture 30c. The flow orientation unit 32c includes a further flow orientation element 92c associated with the further dust and/or chip diversion aperture 40c. The flow orientation elements 92c, 98c are each configured as channels 64c running obliquely through a wall 62c of the lower saw blade guard 24c. The flow orientation unit 32c, in particular the flow orientation element 98c, is configured to divert an airflow 94c comprising dust and/or chip particles passing through the dust and/or chip diversion aperture 30c into a lateral direction 36c that is angled with respect to a saw blade surface 38c of the saw blade area 22c. The flow orientation unit 32c, in particular the further flow orientation element 92c, is configured to divert the airflow 94c comprising dust and/or chip particles passing through the further dust and/or chip diversion aperture 40c into a lateral direction 42c which is oppositely angled with respect to the saw blade surface 38c of the saw blade area 22c compared to the lateral direction 36c.

In FIG. 6, a schematic cross-sectional view is shown through a portion of a third alternative dust and/or chip diversion device 72d and through a portion of a saw blade 14d. The third alternative dust and/or chip diversion device 72d comprises an upper saw blade guard 16d and a lower saw blade guard 24d that can be retracted into the upper saw blade guard 16d. In the illustration of FIG. 6, the lower saw blade guard 24d is retracted straight into the upper saw blade guard 16d. The lower saw blade guard 24d comprises a dust and/or chip diversion aperture 30d. The lower saw blade guard 24d comprises a further dust and/or chip diversion aperture 40d. The further dust and/or chip diversion aperture 40d is arranged adjacent to the dust and/or chip diversion aperture 30d in a direction 102d extending parallel to a saw blade axis 12d and/or perpendicular to a circumferential direction of the saw blade 14d or a saw blade area 22d of the third alternative dust and/or chip diversion device 72d. The dust and/or chip diversion apertures 30d, 40d are arranged exclusively in lateral surfaces 58d/lateral walls of the lower saw blade guard 24d. The third alternative dust and/or chip diversion device 72d comprises a flow orientation unit 32d. The flow orientation unit 32d includes a flow orientation element 98d associated with the dust and/or chip diversion aperture 30d. The flow orientation unit 32d includes a further flow orientation element 92d associated with the further dust and/or chip diversion aperture 40d. The flow orientation elements 92d, 98d are each configured as channels 64d running obliquely through a wall 62d of the lower saw blade guard 24d. The lower saw blade guard 24d has a radial outer side 44d. A recess 46d is formed in an area of the radial outer side 44d arranged between the dust and/or chip diversion aperture 30d and the further dust and/or chip diversion aperture 40d. The recess 46d forms a vortical chamber. The vortical chamber allows for optimal swirling of the airflow 94d passing through the dust and/or chip diversion apertures 30d, 40d (see also the arrows in FIG. 6).

What is claimed is:

1. A dust and/or chip diversion device for a handheld power tool which has a saw blade that generates dust and/or chips and is rotatable about a saw blade axis, the dust and/or chip diversion device comprising:
an upper saw blade guard which is configured to permanently cover, at least to a large extent, a part of a saw blade area receiving the saw blade, wherein the saw blade area of the handheld power tool faces away from a workpiece machining area;
a lower saw blade guard movably mounted relative to the upper saw blade guard, wherein the lower saw blade guard is configured to cover, at least to a large extent, a part of the saw blade area facing toward the workpiece machining area at least in an idle state and at least during a sawing operation in which the saw blade is immersed in a workpiece to at least partially release the part of the saw blade area facing toward the workpiece machining area at least by at least partially retracting into the upper saw blade guard, and wherein the lower saw blade guard includes at least one dust and/or chip diversion aperture via which dust generated by the rotating saw blade and/or chips generated by the rotating saw blade are diverted from the saw blade area; and
a flow orientation unit which is at least configured to selectively divert at least dust and/or chip particles passing through the dust and/or chip diversion aperture from a radial direction perpendicular to the saw blade axis.

2. The dust and/or chip diversion device according to claim 1, wherein the flow orientation unit is configured to divert the dust and/or chip particles passing through the dust and/or chip diversion aperture at least in a lateral direction which is angled with respect to a saw blade surface of the saw blade area.

3. The dust and/or chip diversion device according to claim 1, wherein the lower saw blade guard comprises at least one further dust and/or chip diversion aperture arranged adjacent to the dust and/or chip diversion aperture in a direction parallel to the saw blade axis.

4. The dust and/or chip diversion device according to claim 2, wherein the flow orientation unit is configured to divert the dust and/or chip particles passing the further dust and/or chip diversion aperture at least in a further lateral direction which is oppositely angled with respect to the saw blade surface of the saw blade area compared with the lateral direction.

5. The dust and/or chip diversion device according to claim 3, wherein a recess forming a vortical chamber is arranged on a radial outer side of the lower saw blade guard between the dust and/or chip diversion aperture and the further dust and/or chip diversion aperture.

6. The dust and/or chip diversion device according to claim 1, wherein the flow orientation unit is configured to divert the dust and/or chip particles passing through the dust and/or chip diversion aperture at least in an outwardly oriented direction which extends parallel to a saw blade surface of the saw blade area and is angled with respect to the radial direction.

7. The dust and/or chip diversion device according to claim 6, wherein the outwardly oriented direction into which the dust and/or chip particles passing through the dust and/or chip diversion aperture are diverted by the flow orientation unit is different from a tangential direction of the saw blade of the saw blade area.

8. The dust and/or chip diversion device according to claim 7, wherein an angle between the tangential direction of the saw blade of the saw blade area and the outwardly oriented direction into which the flow orientation unit diverts the dust and/or chip particles passing through the dust and/or chip diversion aperture is less than less than 45°.

9. The dust and/or chip diversion device according to claim 1, wherein the lower saw blade guard includes at least one additional dust and/or chip diversion aperture arranged in an external circumferential direction around the saw blade area in front of or behind the dust and/or chip diversion aperture.

10. The dust and/or chip diversion device according to claim 9, wherein:
in a state of the lower saw blade guard being maximally retracted into the upper saw blade guard, the dust and/or chip diversion aperture and the additional dust and/or chip diversion aperture are each differently spaced apart from the interior walls or interior wall areas of the upper saw blade guard.

11. The dust and/or chip diversion device according to claim 1, wherein the dust and/or chip diversion aperture is partially or entirely arranged on a lateral surface of the lower saw blade guard.

12. The dust and/or chip diversion device according to claim 1, wherein the flow orientation unit is at least partially formed by a channel running obliquely through a wall of the lower saw blade guard.

13. The dust and/or chip diversion device according to claim 1, wherein the flow orientation unit is at least partially formed by a tab/spoiler that protrudes externally at least partially through the dust and/or chip diversion aperture.

14. The dust and/or chip diversion device according to claim 1, wherein the upper saw blade guard includes a connection interface configured to connect with a dust and/or chip container and/or a vacuum cleaner hose.

15. A handheld circular saw, having a saw blade area into which a saw blade can be mounted such that a workpiece arranged in a workpiece machining area of the handheld power tool can be machined by way of the saw blade, and having a drive unit configured to generate a rotation of the saw blade arranged in the saw blade area about a saw blade axis of the drive unit, and having the dust and/or chip diversion device according to claim 1.

16. The dust and/or chip diversion device according to claim 1, wherein the upper saw blade guard is arranged in a stationary manner.

17. The dust and/or chip diversion device according to claim 1, wherein the lower saw blade guard is rotationally movably mounted about the saw blade axis.

18. The dust and/or chip diversion device according to claim 1, wherein the flow orientation unit is at least configured to selectively divert at least dust and/or chip particles passing through the dust and/or chip diversion aperture from the saw blade area.
